(19) United States
(12) Patent Application Publication
(10) Pub. No.: US 2025/0227463 A1
(43) Pub. Date: Jul. 10, 2025

(54) MOVEMENT VERIFICATION SYSTEM AND METHOD

(71) Applicant: SweatCo Limited, London (GB)

(72) Inventors: Oleg FOMENKO, London (GB); Anton DERLYATKA, London (GB); Egor KHMELEV, London (GB); Stylianos KAMPAKIS, London (GB); Daniil OKHLOPKOV, London (GB); Oleg PODDUBNY, London (GB)

(73) Assignee: SweatCo Limited, London, LN (GB)

(21) Appl. No.: 18/809,920

(22) Filed: Aug. 20, 2024

Related U.S. Application Data
(63) Continuation of application No. 17/768,578, filed on Apr. 13, 2022, now abandoned.

(30) Foreign Application Priority Data
Oct. 14, 2019 (GB) 1914863.4

(51) Int. Cl. H04W 12/033; G01C 22/00; H04L 9/32

(52) U.S. Cl. CPC H04W 12/033; G01C 22/006; H04L 9/3213

(57) ABSTRACT

Movement verification methods and systems are disclosed. These methods and systems are configured to determine user movement that is characterised by a sequence of repeated user actions—such as steps or bicycle crank revolutions. A user mobile device is positioned in proximity to a user so as to register the movement of that user. The user mobile device comprising a sensor set and is configured to generate from that sensor set an unverified set of movement data resulting from user movement. A movement verifier is in communication with the mobile user device. The movement verifier is configured to receive the unverified set of movement data from the user mobile device and apply a movement verification function that compares the unverified set of movement data against a model so as to verify user movement that is characterised by a sequence of repeated user actions, such as steps.

### CROSS REFERENCE TO RELATED APPLICATIONS

This application is a continuation of U.S. patent application Ser. No. 17/768,578 filed on Apr. 13, 2022; which claims priority to International Patent Application PCT/GB2020/052557 filed on Oct. 14, 2020; which claims priority to UK Patent Application GB 1914863.4 filed on Oct. 14, 2019; the entire disclosures of which are hereby incorporated by reference and relied upon.

### BACKGROUND OF THE INVENTION

### Field of the Invention

The present invention relates to devices, systems and methods relating to movement tracking and verification. In particular, the present invention relates to the verification of physical movement or exercise in incentive and reward systems and methods.

### Background of the Invention

Inactivity and lack of exercise is a growing health problem, especially in the developed world where many people have increasingly sedentary lifestyle. This can put a serious burden on healthcare systems, and lead to a general decrease in the productivity of the workforce—for example, through employee sickness.

Accordingly, governments and businesses have a variety of initiatives to promote exercises such as walking and cycling. “Ride-to-work” schemes are one example where discounts provide an incentive to buy exercise equipment such as bicycles. However, owning such exercise equipment does not necessarily lead to increased activity and exercise.

One possible solution is to provide rewards in response to monitored participation in exercise activities. Rewards need not necessarily be monetary in nature. Instead, they can be virtual rewards—for example, achievements badges, medals or the like, presented via an exercise monitoring platform.

Such exercise monitoring platforms are typically set up to receive data from mobile user devices such as smartphones and/or dedicated fitness wearables. In addition to this, social networks through which such rewards or achievement can be advertised, can provide a reinforcing effect on users to exercise more. Social status as an individual that exercises regularly, and is fit and healthy, can be a powerful reward in itself.

However, one problem emergent from providing rewards for exercise is that users may attempt to cheat or exploit such platforms simply to acquire those rewards or social status. This is usually achieved by dishonestly manipulating the user device which acts as a means of monitoring exercise. For example, devices acting as pedometers can erroneously register steps if they are shaken.

Knowledge that the reward platform can be exploited leads to lower trust and engagement, resulting in fewer users being attracted to the platform and those users of that platform exercising less.

Accordingly, one problem to be solved is how to verify that a user of such a platform has genuinely performed exercise. In particular, what is required is a way to confidently and reliably determine predetermined types of physical activity, as measured by a user mobile device like a smartphone, which is worn, carried, or otherwise in proximity to the user. This needs to be reliable enough to work under conditions where the response and placement of the device, and use by the user may be relatively unpredictable. Furthermore, it is necessary to achieve this whilst being simultaneously resilient against “gaming”—i.e. attempts to manipulate that device to falsely register such exercise activity. Minimising both false positives caused by “gaming” and false negatives (i.e. discarding of genuine movement in error) is important to increase user trust and engagement.

Additionally, it is desirable for a solution not to place an undue burden on users, or drain resources such as battery power from the user mobile device being used as a means of monitoring activity. This presents a significant technical challenge.

A further related problem to be solved is how verified movement can be effectively incorporated into a reward system that can be universally trusted.

It is against this background that the present invention has been conceived.

### SUMMARY OF THE INVENTION

According to a first aspect of the present invention there is provided a movement verification and/or tracking system. The system may comprise at least one or combination of the features recited in the accompanying claims.

The system may be for determining user movement. Preferably, the system may be for determining user movement that is characterised by a sequence of repeated user actions such as steps, or bicycle revolutions. Naturally, the system may be configured for the accurate detection and/or inference of those repeated user actions.

The system may comprise at least one of a user mobile device and a movement verifier. Preferably, the user mobile device is positionable in proximity to a user so as to register the movement of that user.

Moreover, the user mobile device may comprise a sensor set. The device may be configured to generate from that sensor set an unverified set of movement data resulting from user movement.

The movement verifier may be in communication with the device. The movement verified by thus be able to receive said unverified set of movement data from the mobile device. Naturally, the mobile device may be configured to transmit the unverified set of movement data to the movement verifier.

The movement verifier may be configured to receive said unverified set of movement data and apply a movement verification function to verify user movement.

Application of the movement verification function may comprise the execution of a predetermined movement verification algorithm, Application of the movement verification function may comprise comparing the unverified set of movement data against a model. Accordingly, user movement that is characterised by a sequence of repeated user actions, (such as steps) can be verified.

The sensor set may comprise at least one inertial measurement unit, such as an accelerometer or a gyroscope. The sensor set may comprise at least one reference-based positioning module, such as a GPS module. Preferably, the sensor set is queried over a user movement period to generate corresponding time-referenced data sets.

Each data set may be converted into at least one activity metric, representing movement activity performed by the user within a user movement period. The activity metrics of the different data sets can then be compared against one another as a cross-check to assist in the verification of user movement performed by the user during the user movement period.

For example, the activity metric could be in the form of a distance travelled, and the data sets could those generated, respectively, by an inertial measurement unit, and a positioning module. Thus, each data set may be converted into a corresponding distance travelled by the user within the user movement period, at least one distance derived from the at least one inertial measurement unit being compared to at least another distance derived from the at least one positioning module as a cross-check to assist verification of user movement performed during the user movement period.

Another activity metric could be in the form of, or derived from at least one of: power exerted by the user, cycling cadence, heart rate and speed. These can be calculated from one or more data sets generated by sensor set of the mobile device, Furthermore, the mobile device may comprise multiple interconnected user devices, each with at least one corresponding sensor. For example, the mobile device may comprise at least two of: a smartphone, a heartrate tracker, a wearable fitness device, a cycling cadence sensor, a cycling wheel speed sensor, and a cycling power meter.

Where the activity metric is in the form of distance travelled, as detected via at least one positioning module and an inertial measurement unit, it is advantageous for the at least one positioning module to be queried at a frequency that is at least ten times lower than the query frequency of the at least one inertial measurement unit. More preferably, the at least one positioning module is queried at a frequency that is at least 100 times lower than the query frequency of the at least one inertial measurement unit. This allows distance to be reliably detected without draining a battery or other power source of the mobile device.

Preferably, the user mobile device is configured to process at least a portion of the unverified movement data prior to transmission by the user mobile device to the movement verifier. This has a number of advantages, including reducing the bandwidth usage of transmission.

Processing, by the user mobile device, of the unverified movement data may comprise shifting the unverified movement data from the time domain to the frequency domain. For example, processing of the unverified movement data may comprise applying a FFT function.

The user mobile device may be configured to pre-categorise the unverified set of movement data prior to transmission by the user mobile device to the movement verifier. For example, the pre-categorisation could be whether the user movement is walking, running or cycling. Advantageously, this can reduce the complexity of, and thus improve the reliability of processing that data to verify movement.

The user mobile device may be configured to include one or more additional parameters within the unverified data set, the movement verifier applying the movement verification function in response to the value of the one or more additional parameters. For example, the one or more additional parameters may comprise at least one of: information about the hardware configuration of the user mobile device, biometric information about the user, such as stride length, heart rate, speed, and cadence.

The user mobile device may be configured to implement a power-saving strategy by inferring periods of inactivity, and in response, during that period, reduce the rate at which the sensor set is queried. For example, the mobile device may be configured to infer a period of activity by detecting that physical movement, as measured by an inertial measurement unit, is below a threshold value. Alternatively, or in addition, the mobile device may be configured to infer a period of inactivity by detecting that the heart rate of a user, as detected by a heart rate monitor, is below a threshold value. In response, the mobile device can reduce the query rate of the sensor set. Moreover, and advantageously, the sensors of the sensor set that have a higher power usage (e.g. a GPS module) can be prioritised as those that are queried less frequently in response to inferring periods of inactivity.

The movement verification function comprises passing the unverified movement data through a neural network. Preferably, the neural network has been trained by training data, and the training data including model movement data sets augmented with trusted desired output values corresponding to the presence and timing, within that model movement data set, of candidate repeated user actions.

The training data may be generated from paired data sets generated by devices that are collocated at a trusted user producing user movement characterised by a sequence of repeated user actions, such as steps. The paired data sets from which the training data is generated, may be pre-processed to improve the pairing between them. For example, pre-processing may comprise time-aligning the paired data sets, for example, using cross-correlation.

Preferably, the training data is segmented into epochs for training the neural network via k-fold cross-validation. Preferably, the training data comprises data sets pre-transformed into the frequency domain. For example, the data sets may be pre-transformed into the frequency domain by application of a FFT function.

Preferably, the system comprises a token generator. The token generator may be configured to generate a token. The token may comprise a token value. The token may be transactable. In particular, the system may be configured to perform transaction operations in which the token may be exchanged for goods or services. The mobile device may comprise a transaction interface allowing a user to view tokens, and/or their value, and select goods and services to receive in exchange for at least part of the value of the tokens.

Preferably, the token generator is communicatively coupled to the movement verifier. The token generator may be arranged to receive the corresponding set of verified movement data, and in response generate a token. Naturally, the movement verifier may be configured to transmit the corresponding set of verified movement data to the token generator, and in response, the token generator generates a token. The token may take the form of a data structure. The data structure of the token may include at least one of: a representation of the verified movement data, and also an identifier unique to the user and/or user mobile device from which that verified movement data originates.

Access to a first set of data within the token, or first set of transactional functions that can be performed on the token, may be cryptographically restricted to said user and/or user mobile device.

Preferably, the system comprises a token management system. The token generator may be configured to transmit the token to the token management system.

Preferably, the token management system is configured to store the token in a cryptographically-secure, publicly-accessible distributed ledger.

According to a second aspect of the present invention there is provided a method of verifying and/or tracking movement. Ideally, the method is a computer-implemented method. The method may comprise at least one or combination of the features recited in the accompanying claims, or in relation to the first aspect of the present invention.

In particular, the method may be a method of verifying user movement, the user movement being characterised by a sequence of repeated user actions such as steps. The method may comprise positioning a user mobile device in proximity to a user so as to register the movement of that user. The method may comprise generating, via a sensor set of the user mobile device, an unverified set of movement data resulting from user movement. The method may further comprise applying a movement verification function that verifies user movement characterised by a sequence of repeated user actions, such as steps. The movement verification function may verify user movement by comparing the unverified set of movement data against a model.

Further aspects of the present invention may reside in components or sub-components of the system of the first aspect, and/or steps of the method of the second aspect. For example, a further aspect may reside in a mobile device of the system of the first aspect.

It will be understood that features and advantages of different aspects of the present invention may be combined or substituted with one another where context allows. Furthermore, such features may themselves constitute further aspects of the present invention.

### BRIEF DESCRIPTION OF THE DRAWINGS

In order for the invention to be more readily understood, embodiments of the invention will now be described, by way of example only, with reference to the accompanying drawings in which:

FIG. 1 is a schematic overview of a system of an embodiment of the present invention, the system comprising a mobile device;

FIG. 2 is a schematic block diagram of the mobile device of FIG. 1; and

FIG. 3 is a block diagram showing the processing structure of a neural network applied by the system of FIG. 1.

### SPECIFIC DESCRIPTION OF THE PREFERRED EMBODIMENT

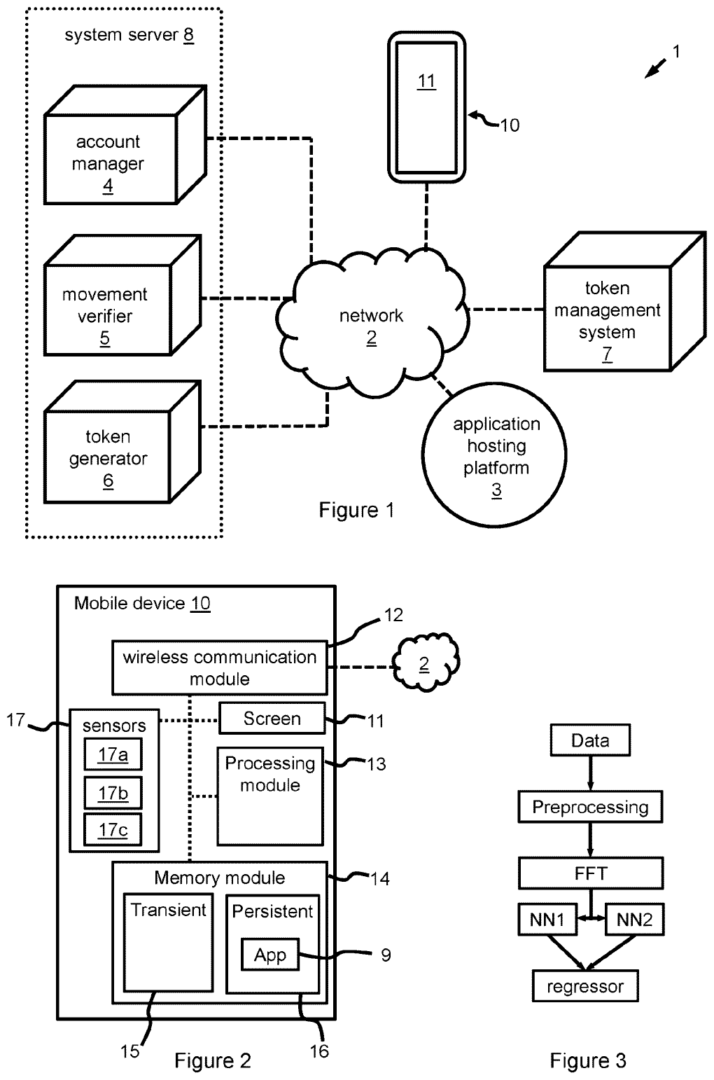

FIG. 1 is a schematic overview of a system 1 of an embodiment of the present invention. The system 1 comprises an application hosting platform 3, an account manager 4, a movement verifier 5, a token generator 6, a token management system 7 and a user mobile device 10. Each are communicatively interlinked to one another via a communications network 2.

It should be noted that, in this preferred embodiment of the present invention, the account manager 4, the movement verifier 5 and the token generator 6 are provided via a system server 8. Thus, communication between these components can take place via a communications network internal to that server 8. Nonetheless, their separation in FIG. 1 is shown schematically to illustrate their functional role and relationship.

Moreover, it will be understood that the system server 8, or other servers referred to herein, may not necessarily be in the form of a single physical machine. The term “server” may encompass, for example, a distributed or “cloud” computing service, engine, service or platform.

Furthermore, in alternatives, components of the system server 8, such as the account manager 4, the movement verifier 5 and the token generator 6, may be provided at least in part and/or functionally on the mobile device 10.

The mobile device 10 is in the form of a smartphone having a touch-sensitive display screen 11 on which can be displayed user interface (UI) elements. These can communicate a state of the mobile device 10 or system 1 to the user, or provide a means by which a user can input information to the mobile device 10 via interacting with those UI elements. UI elements may be used, for example, to provide feedback to the user about how much movement or exercise (e.g. steps) that the mobile device 10 has registered. In alternative embodiments, the mobile device 10 may be embodied as multiple interconnected user devices—for example, a Bluetooth™ interconnected smartphone and a wearable fitness device comprising a heart-rate tracker.

It will be understood that, in practice, the system 1 will have a plurality components of the same type. For example, there could be many mobile devices, possibly numbering in the thousands or millions, or more. However, for clarity, a single system component type (e.g. mobile device 10) is depicted in FIG. 1, and representative of each of the potentially multiple components of that type.

FIG. 2 is a schematic block diagram of the mobile device 10 of FIG. 1. The mobile device 10 further comprises a wireless communication module 12 for interfacing with the network 2, a processing module 13, and a memory module 14. The mobile device 10 also comprises a sensor set 17, including an IMU (inertial measurement unit) having an accelerometer 17a and gyroscope 17b. For the avoidance of doubt, the accelerometer 17a is arranged to detect and report 3-axis linear acceleration, for example, measured along Cartesian coordinates (x, y, z). The gyroscope 17b is arranged to detect and report rotational acceleration, for example about those axes (e.g. pitch, roll and yaw). The sensor set also includes a reference-based positioning module 17c in the form of a GPS module which can infer and report an absolute position of the mobile device 10 on Earth, and moreover, can provide a stable and highly reliable timing reference in a manner known in the art.

The memory module 14 comprises a transient memory 15 such as a cache, for transiently storing data, and a persistent memory 16 within which an operating system, file system and applications of the mobile device 10 are stored and executed via the processing module 13 at run-time. The operating system ideally comprises app power management facilities to switch apps between wake and sleep states, as will be described further below.

The mobile device 10 further comprises other components that are typically common in smart-phone and tablet devices, but are not necessarily shown in the drawings. By way of non-limiting example, these other components include other sensors such as a light intensity sensor, a proximity sensor, an internal pedometer and compass. Furthermore, other components include a battery, a timer, audio transducers, tactile transducers (e.g. vibration transducer), and a clock. The components of the mobile device 10 are functionally and communicatively linked to one another as schematically indicated by the dotted lines in FIG. 2. The mobile device 10 may also comprise additional communication modules (e.g. WiFi, BLE/Bluetooth, cellular etc), to allow communication with other components or sub-components of the system 1.

Components such as the internal pedometer may take the output from other sensors, such as those from the IMU, process them, and provide a derived data set as its own output. Naturally, such functions may be implemented by the chipset of a mobile device 11.

Referring back to FIG. 1, by way of overview, the system 1 is configured to make an application (or “app”) available for download on to the mobile device 10. The downloading and execution of the app 9 provides functionality otherwise not available to that mobile device 10.

In particular, the app 9 provides some of the functionality of the enhanced method of movement verification, as will be described in greater detail below. The provision of the app is ideally via the network 2 from a third-party application hosting platform 3, for example, an Android or iOS “app store” as is well-known in the art. In some examples, a hyperlink or similar may be provided via the UI elements of the mobile device 10, which-when selected by a user-guides the mobile device to the location of the appropriate application hosted by the app hosting platform 3.

The app 9, when run or managed by the mobile device 10, in conjunction with the app hosting platform 3, is configured to automatically detect when the application requires updating, and can automatically updates itself (optionally first prompting a user to affirm that an update should take place). Furthermore, the app 9 is configured to establish a communication link via the network 2 between the mobile device 10 and the other components of the system 1.

In particular, the mobile device 10 is controlled by the app 9 to communicate with the account manager 4 of the system server 8 for the purpose of setting up and accessing a user account specific to an individual user of the mobile device 10. Additionally, a set of movement data collected by the mobile device 10 under control of the app 9 is transferred via the network 2 to the movement verifier 5. Such movement data is sampled over time from the sensor set and timestamped. Accordingly, simultaneously-generated data from different sensors will have the same or very similar timestamps.

The set of movement data evidences movement undertaken by that user over an exercise period, and so receipt by the movement verifier 5 is for the purpose of verifying the validity of that movement data. The movement verifier 5 also verifies or generates values of parameters associated with that movement data. A parameter could be the type of movement (e.g. steps taken by the user carrying the mobile device) and the value of that parameter could relate to, for example, the length of the exercise period and/or the movements performed (e.g. the number of steps taken).

Once movement data is verified, the movement verifier can pass a verified movement notification to the account manager 4 for logging against an individual user's personal account. This allows a user to utilise multiple different mobile devices over time to track their movement and exercise.

Moreover, the verified movement notification is sent from the movement verifier 5 to the token generator 6 of the sever 8 for the purpose of generating a token. The token takes the form of a data structure that includes a representation of the verified movement data and also an identifier unique to the user and/or mobile device from which that verified movement data originates. Access to a first set of data within the token and/or first set of transactional functions that can be performed on the token, are cryptographically restricted to said user and/or mobile device. A second set of data within the token, and/or second set of transactional functions performable on the token, are cryptographically restricted to the system server 8 (or components thereof).

In other words, the token can have two components, each of which is cryptographically restricted—for example, encrypted using PKI encryption. One component represents the user, and the other represents the verified movement. In this particular example, the encryption allows only the holder of a private key to perform certain operations on each component. Typically, the user holds the private key for performing operations (e.g. transfer operations) on the user component, and the system server 8 holds the private key for performing operations on the component representing the movement. (e.g. for certification).

Accordingly, the token can be transmitted via the network 2 to the token management system 7 for storage and other data management functions such as transactions. Ideally storage of tokens is supported by a cryptographically-secure database, and in one embodiment, the token management system 7 includes a database in the form of a publicly-accessible distributed ledger and structured as a “blockchain”. Such a token management system 7 can be implemented via the Etherium® platform, for example. The advantage of this approach is that the provenance of the user that results in token generation, registered ownership of that token, and subsequent transactions performed in respect of that token, are computationally unfeasible to subvert. Yet the information concerning provenance and ownership is publicly-accessible leading to trust in the manner in which such tokens are stored and handled. In other words, there is no single, central authority that is entrusted with the storage and handling of tokens-rather, the integrity of the tokens are cryptographically protected, potentially increasingly so as subsequent tokens are added to the database (as a blockchain).

A first set of transactional functions performed in respect of the tokens stored on the database can thus be securely-controlled by the appropriate user and/or mobile device responsible for originating a respective token. A second set of transactional functions (e.g. certification/checks of those tokens) can be securely-controlled by the server 9, or its relevant components.

Advantageously, this arrangement forms a robust technical framework for measuring and rewarding user movement and exercise. The fact that the database within which verified tokens are stored is cryptographically-secure, distributed, and publicly-accessible means that users of the system 1 can have a high degree of trust that their movement and exercise is being recorded in the database in a way that is not controlled by a central authority without their permission (e.g. those controlling the server 8). However, the involvement of the server 8 to verify the movement in the first place adds credibility that the tokens are an accurate representation of movement and exercise. The latter is an important component for subsequent transactions carried out in respect of those tokens.

It should be noted that in alternative embodiments of the invention, a centralised model may be used instead, or at least in combination with the previously-described embodiment. In such a centralised model, an alternative token management system 7 may be used which is implemented by a central server, such as the system server 8, having a central database in which the tokens are stored. Typically, in such a centralised model, the database is not entirely publicly-accessible or distributed, with both issuance of and control over the tokens being governed by the server. Whilst this has certain drawbacks, a centralised model is generally less complex, more easily updatable, and quicker to operate than a decentralised model. For example, transactions involving the transfer of a value represented by tokens need not be publicly cryptographically verified, and so will not suffer from relatively slow transaction speeds.

Regardless of how a token is generated and stored, as mentioned above, the ability to perform token transactions are an important aspect of linking value to user movement.

For example, the tokens may be used by third parties to modify their goods or services in response to an individual's exercise and movement profiles, as represented by those tokens. For example, third parties like insurance brokers may offer more favourable premiums to users that can demonstrate a good level of regular fitness and movement. Healthcare professionals can use the tokens as an evidence base to continue with, or alter a regime of treatment. Fitness trainers can use the tokens to modify an exercise training plan. Retailers may use the tokens to advertise appropriate goods to individuals having a particular verified movement profile (e.g. running shoes for running enthusiasts, or bike components to regular cyclists) together with discounts on those goods.

However, these benefits and uses of the system 1 are all underpinned by the reliable verification of user movement. Without such verification, any generated tokens would not necessarily provide a credible and accurate representation of movement and exercise. Accordingly, examples of how movement is verified by the movement verifier 5 of the system server 8 will now be discussed.

The movement verifier 5 comprises a processor which is configured to perform a movement verification function. The movement verification function receives as an input a set of unverified movement data from the mobile device 10 (or as the case may be, each of the many mobile devices 10 of the system). The output of the movement verification function is generally referred to herein as verified movement, or verified movement data. This can take the simple form of a parameter such as the number of verified steps taken or the number of bicycle crank revolutions performed. As mentioned, in certain alternatives to the present embodiment, components such as the movement verifier may be provided partly and functionally on the mobile device 10. Thus, at least part of the movement verification function may be undertaken on the mobile device 10.

For greater accuracy, and to reduce the processing burden on the movement verifier 5, the set of movement data received may be pre-categorised as a particular type of movement—for example steps taken by a user. The pre-categorisation is ideally performed by the mobile device 10 responsible for initially generating the set of movement data, and may be an inherent assumption—for example, resulting from an app, or system configuration designed purely for the purpose of detecting and verifying steps, as opposed to any other category of movement. However, it will be appreciated that, in alternatives where there are multiple activity category possibilities, the category of movement may need to be first determined. Categorisation may be performed by the server 8 or mobile device 10 running the app 9. This may simply involve choosing between a finite number of alternative categories—e.g. cycling movements, or steps.

It should be noted that the present embodiment is particularly relevant to movement characterised by a sequence of repeated user actions-such as steps. This is because the efficacy of the present embodiment benefits from statistical properties of data generated by such a sequence of repeated user actions. Specifically, the present embodiment is particularly applicable to user actions that generate a corresponding sequence of action data sets which are correlated with one another- and wherein a subset of data relating to any one repeated movement (like a step) is likely to be relatively correlated with data relating to any other repeated movement (like another step). Nonetheless, whilst steps are used as the main illustrative example herein, the present invention may be embodied by, and naturally extend to other sequences of repeated user actions. For example, the repeated user action could be a cycling action such as the cyclical movement of turning of a bicycle crank repeatedly. Other quantities may also be measured and transmitted to the movement verifier 5 in addition to movement. For example, heart rate, or heart rate changes may be measured. Data such as this can be acquired by the mobile device 10 from an interconnected device, such as a wearable heart-rate tracker-such as an Apple® watch for example.

The movement verifier 5 generally performs its function by comparing unverified movement data against a model. The model includes a range of signals that are expected to result from the sensors of the mobile device in response to a particular movement type. Such a model may be generated via traditional linear model building methods, adaptive model building methods, or a combination of the two.

For example, the movement verification function itself could be derived and/or improved using predictive modelling or machine learning methods. In the present embodiment discussed herein, one variant of the movement verification function comprises a neural network.

In an initial stage, this neural network is trained using initial training data that includes model movement data sets generated by a variety of mobile devices, each set being augmented with trusted desired output values corresponding to the exact presence and timing of steps (or other repetitive actions, such as bicycle revolutions).

More specifically, the training data is generated by pairing each model movement data set with a trusted data set that has been contemporaneously-generated by a second, dedicated research-grade activity monitor worn at a predetermined location relative to a user's body or exercise equipment. An example of such an activity monitor is an ActiGraph® GT3X+ activity monitor produced by ActiGraph Corp, Pensacola, FL, USA. Such a dedicated activity monitor is typically worn around a user's ankle.

The activity monitor and mobile device that generate the paired data sets are collocated at the user producing the repeated movement. For example, the mobile device may be located within the pocket of the user, and the activity monitor is attached to a leg of the user. Furthermore, training data is obtained through movement and exercise of trusted users that do not have an incentive to cheat or otherwise generate unreliable data.

The collocated dedicated activity monitor and mobile device are independent, and so aren't likely to share a common time-reference. Accordingly, to correct for this, the model movement data set from the mobile device and the trusted data set are time-aligned with one another using cross-correlation and, where necessary, other statistical enhancements such as interpolation, and quantisation are applied to clean and homogenise the paired data sets, and otherwise improve pairing between the data sets that correspond to the same user movement. The trusted desired output values can thus be generated by using the trusted data set as a guide to the exact presence and timing of steps.

The paired model and trusted data sets are also ideally segmented, for example being split into a sequence of epochs relating to a movement period of predetermined duration. It has been determined that a sequence of epoch, each approximately 5 seconds in duration, are particularly suitable for providing training to the neural network to recognise step movement effectively, especially when neural network training methods such as k-fold cross-validation are utilised. Each epoch can thus be utilised sequentially, and so facilitates iterative training of the neural network.

An additional step, prior to feeding the training data to the neural network, includes transforming the paired model and trusted data sets into the frequency domain by applying a Fast Fourier Transform function (FFT) to them. This has the advantage of converting the data sets into a compact representation of their original form, requiring significantly less storage than that of the original, with a relatively modest processing overhead required to execute the FFT function. Furthermore, it has been surprisingly determined through testing that the use of an FFT function significantly improves results. In alternatives, however, other suitable transforms may be used for the same purpose. For example, such transforms can be Wavelet Discrete Transform, or Convolutional Neural Net representations.

There various ways that the neural network can be structured. However, an example determined structure involves a combination of three different models as shown in FIG. 3. After cleaning/pre-processing data and applying an FFT function as described above, data is simultaneously passed to both a first component of the neural network (NN1) and a second component of the neural network (NN2). Naturally, such components may themselves be considered as neural networks or models in their own right.

NN1 is a deep neural network that outputs a probability as to whether or not the data within the 5 second epoch is a step (or a sequence of steps). NN2 is deep neural network that outputs the total number of steps walked. In a preferred embodiment, both NN1 and NN2 take as their input a first 200 coefficients of FFT from the accelerometer and gyroscope amplitude values in the training (e.g. model) data sets described.

With this arrangement, typical performance metrics, based on 5-fold cross-validation (CV) training are: For NN1-Precision: 99%, recall: 89%, accuracy: 93%; For NN2-Mean Absolute Error (MAE): 0.62, MAE standard deviation: 7.7, MAE maximum: 10.

The output of NN1 and NN2 are then passed to a regressor (ideally a tree-based gradient boosting regressor) together with statistical features calculated over the 5-second epochs/periods. In particular, the mean, median, standard deviation, maximum and range over each 5-second epoch for the following are provided for the model data set (when compared to the trusted data set):
All accelerometer axes
All gyroscope axes
Amplitude of accelerometer
Amplitude of gyroscope
Step counter based on accelerometer amplitude with a predetermined threshold (e.g. of 8)
Step counter based on gyroscope amplitude with a predetermined threshold (e.g. of 12)

Alternative models may omit some of the above parameters. For example, one alternative model may omit the use of gyroscope data, utilising as an input accelerometer data. This results in a timestamp sequence, and x, y, z values. The accelerometer data is split into intervals ranging from fraction of a second to multiple seconds with an option to re-sample at different time durations over the same data set to improve model quality. For each fixed-sized chunk of raw accelerometer data, its module (m=sqrt (x\hat{ }2+y\hat{ }2+z\hat{ }2)) and their derivatives including but not limited to: min, max, std, median, mean, etc. We train tree-based classifier to label each chunk with activity class including walking, running, shaking, etc.

During a training phase, accelerometer data can be labelled based on the user activity (shaking, running, walking, in a vehicle, etc.). From this, target variables can be created for a model to be trained on. Finally, a Random Forest algorithm is utilised to predict the activity class of every predefined interval by using the same pre-agreed parameters used for training of the model.

Thus, the neural network as a whole can be trained on data that is generated by a mobile device subject to conditions that aren't caused by the appropriate user movement. Dishonest users may attempt to shake the mobile device, or otherwise manipulate it in a way that causes steps to be erroneously counted. Data sets like these can be purposefully generated and fed into the neural network under supervision to train the neural network to reject the counting of steps (or other movement) for such data sets. The above alternative algorithm provides one way for this to be implemented.

Accordingly, the movement verifier can reliably determine whether a data set provided to it is derived from user movement over time, and moreover determine with a degree of confidence, verified movement data that includes a value associated with that movement data set (such as the number of steps).

The movement verifier can be further improved or enhanced in its operation by running a binary prediction model, and/or a regression model. Statistics (such as mean, median, maximum, standard deviation, range, skewness, kurtosis) can be compiled in this way that can be used further to train or validate the efficacy of the model.

In any case, application of the movement verification function results in the output by the movement verifier 5 of a verified movement notification to, for example, the token generator 6 of the system server 8 for the purpose of generating a token as discussed above.

Feedback loops can be used to assess and improve model performance, especially for a large number of different users of the system, each generating their own set of movement data to be verified. In general, an initial training data set is used that is intended to represent the typical movement data for more users of the system. Using a feedback loop, the training data set can be updated and improved over time, for example by:
Designating certain users of the system to be “trusted” users (i.e. those that will not attempt to dishonestly generate false movement data), and monitoring and improving the verification quality for these users;
Furthermore, different users can be assigned with different “trust scores”. These trust score can be built up over time, and in response to other movement cross-checking mechanisms (e.g. via GPS tracking). A high trust score can lead to a lower movement verification threshold for movement verification where such cross-checking mechanisms are not available.
Receiving instructive feedback from users about the performance of movement verification (e.g. via various channels, such as App stores reviews, official forums, social networks). Accordingly, movement verification can be updated to address unforeseen issues for unusual exceptions of user use-cases.
Keeping track of, and responding to low verification rates on the general population of users.

When a misclassification sample is reviewed as part of a feedback loop, a trust level, or trust score for a user, who issued such sample, can be considered. For users from outside of the list of the already most trusted users, a trust level can be determined via different verification techniques:
Anomaly test for activity patterns and verification history
Valid device and application metadata
Uniqueness in terms of user metadata and digital fingerprint

To optimise the operation of the system 1 as a whole, the set of movement data collected by the mobile device 10 under control of the app 9, that is transferred via the network 2 to the movement verifier 5, can be subject to similar pre-processing (e.g. application of an FFT transform) prior to transfer from the mobile device 10.

Naturally, the app 9 is configured to control the mobile device 10 to collect a set of movement data equivalent to that of the model movement data set used to train the movement verifier. This is typically timestamped data collected from the IMU, including data from the accelerometer 17a and gyroscope 17b. However, other data sets may be used, such as an output from a dedicated pedometer within the mobile device 10.

This can deliver sufficient information to permit step verification to be performed-especially if those steps are logged by the mobile device 10 under conditions where an external positioning reference, such as that provided by GPS, is unavailable (e.g. walking or running indoors).

However, as an additional enhancement, the app 9 is also configured to control the mobile device 10 to also collect information from the reference-based positioning module 17c. In the present embodiment, this is a GPS module. Pairing this information with that of the IMU sensors provides a way of cross-checking the movement data set.

Specifically, a sequence of repeated user movements, such as steps, will generally result in that user moving a predictable distance. The steps, as detected by the IMU sensors, can be converted into a distance using parameters such as a user stride length. The reference-based positioning module can provide a way to check that the movement of the user along a path has actually occurred, as inferred by the IMU sensors. This can be achieved via the positioning module 17c registering the absolute geographical location of the mobile device, and how this changes over time.

Moreover, by regularly sampling the absolute location of the mobile device 10, the positioning module 17c can ensure that the movement along that distance has occurred over a time period and within an predetermined speed range that is expected for that particular repeated user movement.

For example, steps are expected to result from walking or running, and so expected to be within known tolerances of an average speed. An average walking speed may be expected to be approximately 1.5 metres per second, and an average running speed may be expected to be approximately 3 metres per second. Steps in general, for the vast majority of the population, are likely to be regularly generated at speeds between 1 and 4 metres per second.

Moreover, different speeds-which relate to different movements-will generate different responses from IMU sensors. Walking is likely to generate lower amplitude responses than running for example. Accordingly, logging this additional information relating to regularly-sampled position over time (and thus speed) and providing it to the movement verifier 5 is useful from the perspective of more reliably being able to verify movement data sets.

Other sensors on the mobile device, or connected with it (e.g. accelerometer and/or heart rate) can also be used as the basis of performing a cross-check. For example, when running, it is expected that a users heart rate is higher than when walking.

For embodiments where the positioning module 17c is implemented via reference based radio-localisation (e.g. using GPS signals), it has been determined via experimentation that an ideal position sampling frequency for sampling the absolute position of the mobile device 10 by querying the positioning module 10 is a sample between 3 and 10 seconds (i.e. one third to one tenth of a Hertz). This provides an optimal balance between power drain and providing an accurate reference for cross-checking the IMU data for the expected speeds of user movement (i.e. typically 1-4 metres per second for steps).

Thus, the positioning module 10 sampling rate is at least an order of magnitude lower than the typical sampling rate for querying IMU sensors. i.e. a typical IMU sampling frequency is greater than 4 Hz, and more preferably within the range 10-100 Hz.

However, as the power consumption of an IMU sensor is significantly lower than a positioning sensor—especially one that utilises radio waves for positioning—this does not detract from the ability to simultaneously save mobile device battery power, and also accurately verify user movement.

In certain embodiments of the invention, the movement verifier 5 is configured to apply different models or neural network components in dependence on the absolute speed of the mobile device 10, as detected by the positioning module 17c. In other words, the IMU data will be handled differently, by different models (or neural network components) in order to verify whether a particular movement, or set of movements, have been performed. This is done to account for the significantly different responses of the IMU for different speeds, even if the same type of user movement is being performed. For example, sensor responses generated by walking are very different from running. Naturally, the generation of each such model (e.g. via training of said neural network components) will be based on data collected during movement at a respective absolute speed.

A further enhancement relates to the inclusion—within the data set generated by the mobile device, and sent to the movement verifier—of additional parameters which also may be useful in choosing an appropriate model or neural network for the verification of the IMU data. For example, one parameter may relate to the hardware configuration of the mobile device—such as specific make/model of mobile device 10 used to generate the data. Thus, at the movement verifier 5, a choice can be made as to the appropriate neural network or model to use, as trained using model data generated predominantly from a mobile device of the same or a similar hardware configuration.

Additionally, movement data collected over time from a particular mobile device 10, used by a particular user, can be used to very accurately tailor a standard model or neural network to the responses generated by the IMU of the particular mobile device/user combination. By using a reference-based positioning module 17c (when available) to provide a high confidence of reliable and trusted IMU data allows the tailoring of the standard model. Thus, the tailored model can be used when data is received from that particular user/mobile combination, and data from the reference-based positioning module 17c is unavailable.

It should also be noted that operation of reference-based positioning modules, especially radio-localisation based references such as GPS, can lead to relatively high battery power consumption. This is a problem for many battery-operated mobile devices 10. One intended feature of the app 9 is the ability to be executed on the mobile device 10 in a manner that does not draw significant power from that mobile device 10.

Accordingly, to alleviate power consumption, the app 9 may configure the mobile device 10 to implement one or more power-saving strategies.

A first power-saving strategy comprises a scheduling determination. This can be done by inferring inactivity periods during which the mobile device 10 is not being used by a user undertaking predetermined repeated movements, such as steps. For example, typical inactivity periods could be when a user is asleep, or sitting down (e.g. at a desk at work). The scheduled occurrence of such inactivity periods can be determined by the app 9 over time—for example, by learning a typical weekly schedule of a user. During such determined inactivity periods, the mobile device 10 can be configured by the app 9 to significantly reduce battery power consuming activities controlled by the app 9, and in particular the rate at which the sensor set 17 is queried, or otherwise how or whether data from the sensor set is processed or stored.

A second similar power-saving strategy comprises the app 9 configuring the mobile device 10 to determine regions of immobility—i.e. zones (such as an indoor home or office environment) where a user is unlikely to perform movements that the mobile device 10 and/or system as a whole is able to track and/or verify.

In particular, the app 9 configures the mobile device 10 to determine an immobility zone within which the mobile device 10 is located, and whilst the mobile device 10 resides within that zone, to again significantly reduce app-controlled battery power consuming activities. The location of the mobile 10 within an immobility zone is typically determined via periodically querying certain components of the mobile device 10.

For example, a Wi-Fi module may be periodically queried, and if the mobile device 10 continues to indicate proximity or connection to a particular home or office network, this can indicate that the mobile device 10 is still within the same geographical area. This assumes that the range of a Wi-Fi access point is limited. Similarly, this can be triggered by a partial or complete loss in radio positioning signals, such as GPS signals, as detected by the positioning module 17c, and as caused by the mobile device 10 being moved into an indoor environment.

The significant reduction of battery power consuming activities may be implemented by the app 9 by issuing a command to an operating system of the mobile device 10 that allows the app 9 to enter a low-power sleep state—i.e. be “put to sleep”. The advantage with such an implementation is that control for deactivating the sleep state (i.e. waking the app 9) is handed over to the operating system of the mobile device 10. As the app 9 need not be active, this further reduces the computational burden and power usage of the mobile device 10.

However, for such a command to be practical, it must also be accompanied by a wake instruction that governs under what circumstances the app 9 is to be woken again. i.e. the app 9 provides specific instructions to the operating system of the mobile device 10 as to the conditions under which the app 9 should be reactivated from the sleep state.

In one embodiment, the wake instruction is location dependent, and moreover contingent on the mobile device 10 leaving the immobility zone. The size and position of the immobility zone can therefore have an significant effect on the trade-off between saving battery power, and the accuracy of tracking movements such as steps. If the immobility zone is incorrectly specified, then the app 9 will either be reactivated prematurely-thereby unnecessarily draining power, or too late to register and verify movement.

As mentioned above, one way to specify an immobility zone is with reference to the detection of a specific Wi-Fi access point (e.g. with a specific SSID). However, this demands that the mobile device 10 Wi-Fi transceiver is activated and has been customised to recognize that specific Wi-Fi access point. Additionally, this approach depends on the assumption that the range of the signal of the Wi-Fi access point is a suitable proxy for the extent of the immobility zone. An alternative method utilising the positioning module 17c, as will now be described, is preferable to overcome these assumptions and shortcomings.

During normal operation, data is collected from the sensor set, including the positioning module 17c, and the IMU sensors (accelerometer 17a and gyroscope 17b), with the data from the positioning module 17c acting as a means for cross-checking against the data from the IMU sensors to ensure that a sequence of repeated movements, such as steps have been genuinely performed by a user. This is useful for preventing false positives.

Moreover, the mobile device 10 is configured by the app 9 to repeatedly query the positioning module 17c (e.g. every 3-10 seconds) to determine from it, for each query, position data relating to the absolute location of the positioning module. Furthermore, position data includes an error value corresponding to the uncertainty of the determined location. The magnitude of the error values and so uncertainty of reported location increases in environments where unobstructed signals cannot be received from a positioning references such as satellites (e.g. in indoor or built-up environments).

When a predetermined number of position data queries include error values above a prespecified uncertainty threshold, this indicates an unreliable positioning source to cross-check the IMU sensor data. Accordingly, in response to this, and to minimise the chance of false positives and “gaming” of user-falsified movement, the app 9 ceases to register movements such as steps (e.g. by ceasing the processing or storage of IMU sensor data) and also, to further save the battery power of the mobile device 10, the app 9 triggers a sleep preparation procedure.

The sleep preparation procedure includes calculating the size and position of the immobility zone from a sequence of the most recent position data queries. In particular, the boundary (and so size) of the immobility zone is calculated as a distance from a “last reliably known” location of the positioning module 17c which acts a centre point for the immobility zone.

The “last reliability known” location can be determined using a variety of different position estimation algorithms, such as via the application of a Kalman filter (and variants thereof) utilising a combination of the time (or sequence), the position and the error of each position data query.

The distance that is used to define the size of the immobility zone is predetermined. Whilst the ideal distance depends on the typical performance of the positioning module 17c of the mobile device 10, as a guide for current smartphone GPS capabilities, a distance of between 500 and 1500 metres is suitable. The immobility zone is thus 1-3 kilometres in diameter in this case.

Once the size and position of the immobility zone has been determined, the sleep preparation routine passes this information to an appropriate power management facility of the operating system of mobile device 10 as part of an instruction to put the app 9 into a sleep state, to be reawakened in the event that the location of the mobile device 10 is detected by the operating system to be outside the defined immobility zone. Accordingly, a more appropriate definition of the size and position of the immobility zone can be achieved, together with better criteria to control entry and exit of the app 9 from a sleep state.

A further power-saving feature of the app 9, comprises switching the positioning module 17c between a high-power mode (where position is determined with lower uncertainty) and a low-power mode (where position is determined with higher uncertainty). When using the data from the positioning module 17c as a cross-check of the IMU sensor data to verify repeated user movements (e.g. steps) it is not necessary to constantly maintain the high-power mode. Following a predetermined number of movements, or after a predetermined period within the high-power mode, the app 9 is configured to switch to the low-power mode, but utilise the previously-mentioned position estimation algorithms to ensure the position estimation is sufficient for the purposes of verifying the IMU sensor data has been genuinely generated by a specific repeat user movement.

Advantageously, a further power-saving feature of the system 1 of the present embodiment is that the processing for the verification of movement (and subsequent token generation) is not carried out on any mobile device 10 but rather is performed by the system server 8. This also has the benefit of making the system 1 as a whole more reliable and trusted to distinguish between authentically-generated movement data and that which is fraudulently produced with the intention of cheating the system 1. Thus rewards for user movement can be more fairly provided by the system 1. The system as described above thus solves or at least alleviates many of the problems inherent in the prior art.

In particular, the fact that rewards can be provided in response to accurately detected movement or exercise activities, even under a variety of conditions, minimises cheating of the system, and promotes trust in the system as a whole. Furthermore, the cryptographic tokenization of verified movement provides a secure, convenient and easily-transacted mechanism by which such verified movement can be quantified and incorporated into a reward system.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

What is claimed is:

1. A movement verification system for determining user movement that is characterised by a sequence of repeated user actions, the system comprising:
a user mobile device positionable in proximity to a user so as to register the movement of that user, the user mobile device comprising a sensor set and configured to generate from that sensor set an unverified set of movement data resulting from user movement; and
a movement verifier, including a processor and implemented by a movement verification function performed at least in part by the processor, in communication with the device configured to perform the steps of:
receiving said unverified set of movement data; and
applying a movement verification function that compares the unverified set of movement data against a model so as to verify user movement characterised by a sequence of repeated user actions, wherein the sensor set comprises at least one inertial measurement unit, such as an accelerometer or a gyroscope, and at least one reference-based positioning module, such as a GPS module, wherein the sensor set is queried over a user movement period to generate corresponding time-referenced data sets, each data set being converted into a corresponding distance travelled by the user within the user movement period, at least one distance derived from the at least one inertial measurement unit being compared to at least another distance derived from the at least one positioning module as a crosscheck to assist verification of user movement performed during the user movement period, wherein the at least one positioning module is queried at a frequency that is at least ten times lower than the query frequency of the at least one inertial measurement unit.

2. The system of claim 1, wherein the user mobile device is configured to process at least a portion of the unverified movement data prior to transmission by the user mobile device to the movement verifier.

3. The system of claim 2, wherein the processing, by the user mobile device, of the unverified movement data comprises shifting the unverified movement data from the time domain to the frequency domain.

4. The system of claim 3, wherein the processing of the unverified movement data comprises applying a FFT function by the movement verifier.

5. The system of claim 1, wherein the user mobile device is configured to pre-categorise the unverified set of movement data prior to transmission by the user mobile device to the movement verifier.

6. The system of claim 1, wherein the user mobile device is configured to include one or more additional parameters within the unverified data set, the movement verifier applying the movement verification function in response to the value of the one or more additional parameters.

7. The system of claim 6, wherein the one or more additional parameters comprise: information about the hardware configuration of the user mobile device, and/or biometric information about the user, such as stride length.

8. The system of claim 1, wherein the user mobile device is configured to implement a power-saving strategy by inferring periods of inactivity, and in response, during that period, reduce the rate at which the sensor set is queried.

9. The system of claim 1, wherein the movement verification function comprises passing the unverified movement data through a neural network, the neural network being trained by training data, and the training data including model movement data sets augmented with trusted desired output values corresponding to the presence and timing, within that model movement data set, of candidate repeated user actions.

10. The system of claim 9, wherein the training data is generated from paired data sets generated by devices that are collocated at a trusted user producing user movement characterised by a sequence of repeated user actions.

11. The system of claim 10, wherein the paired data sets from which the training data is generated, are pre-processed to improve the pairing between them.

12. The system of claim 11, wherein the pre-processing comprises time-aligning the paired data sets.

13. The system of claim 9, wherein the training data is segmented into epochs for training the neural network via k-fold cross-validation.

14. The system of claim 9, wherein the training data comprises data sets pre-transformed into the frequency domain.

15. The system of claim 14, wherein data sets are pre-transformed into the frequency domain by application of a FFT function performed by the processor.

16. The system of claim 1, further comprising a token generator, wherein the movement verifier is configured to transmit the corresponding set of verified movement data to the token generator, and in response, the token generator generates a token represented by a data structure that includes at least one of: a representation of the verified movement data, and an identifier unique to the user and/or user mobile device from which that verified movement data originates.

17. The system of claim 16, wherein access to a first set of data within the token, or first set of transactional functions that can be performed on the token, are cryptographically restricted to said user and/or user mobile device.

18. The system of claim 16, further comprising a token management system, implemented at least in part by the processor, wherein the token generator is configured to transmit the token to the token management system.

19. The system of claim 18, wherein the token management system is configured to store the token in a cryptographically-secure, publicly-accessible distributed ledger.

20. A computer-implemented method of verifying user movement, the user movement being characterised by a sequence of repeated user actions, the method comprising:
positioning a user mobile device in proximity to a user so as to register the movement of that user;
generating, via a sensor set of the user mobile device, an unverified set of movement data resulting from user movement; and
applying a movement verification function that compares the unverified set of movement data against a model so as to verify user movement characterised by a sequence of repeated user actions, wherein the sensor set comprises at least one inertial measurement unit, such as an accelerometer or a gyroscope, and at least one reference-based positioning module, such as a GPS module, wherein the sensor set is queried over a user movement period to generate corresponding time-referenced data sets, each data set being converted into a corresponding distance travelled by the user within the user movement period, at least one distance derived from the at least one inertial measurement unit being compared to at least another distance derived from the at least one positioning module as a crosscheck to assist verification of user movement performed during the user movement period, wherein the at least one positioning module is queried at a frequency that is at least ten times lower than the query frequency of the at least one inertial measurement unit.
